(19) United States
(12) Patent Application Publication
(10) Pub. No.: US 2014/0316835 A1
(43) Pub. Date: Oct. 23, 2014

(54) METHOD AND APPARATUS FOR VISUALIZING FIXED AND FLEXIBLE DAILY CALENDAR EVENTS ON A MAP

(71) Applicant: NAVTEQ B.V., Veldhoven (NL)

(72) Inventors: FRANCISCO CORTES, Espoo (FI); JUAN LABLANCA, Espoo (FI)

(73) Assignee: NAVTEQ B.V., Veldhoven (NL)

(21) Appl. No.: 13/868,747

(22) Filed: Apr. 23, 2013

(51) Int. Cl. G06Q 10/10

(52) U.S. Cl. CPC G06Q 10/1095
USPC 705/7.19

(57) ABSTRACT

An approach is provided for visualizing a flow of fixed and flexible daily calendar appointments on a mapping user interface including time, location, and/or transportation information associated with the appointments. A mapping platform determines one or more flexible parameters of at least one flexible appointment based, at least in part, on one or more fixed parameters of at least one fixed appointment. The mapping platform causes, at least in part, a presentation of at least one mapping user interface depicting the one or more flexible parameters, the at least one flexible appointment, the one or more fixed parameters, the at least one fixed appointment, or a combination thereof, wherein the one or more flexible parameters, the one or more fixed parameters, or a combination thereof include, at least in part, one or more location parameters, one or more time parameters, one or more transportation parameters, or a combination thereof.

### BACKGROUND

Service providers and device manufacturers (e.g., wireless, cellular, etc.) are continually challenged to deliver value and convenience to consumers by, for example, providing compelling network services. One area of interest has been the development of calendar services that allow users of mobile devices (e.g., mobile phones and/or tablets) to organize upcoming tasks, appointments, responsibilities, etc. over a period of time (e.g., a day, a week, a month, etc.) and then have that information readily available for viewing on a mobile device. However, users are currently unable to intuitively determine how or when to get from one appointment to the next and/or what points of interest (POIs) are near an appointment that may enable a user to accomplish an ad-hoc task (e.g., buying a birthday present, having a cup of coffee, etc.). Accordingly, service providers and device manufactures face significant technical challenges in providing a service that shows a user his or her entire day on a map along with visual information about how to go from one appointment to another and when to do so.

### SOME EXAMPLE EMBODIMENTS

Therefore, there is a need for an approach for visualizing a flow of fixed and flexible daily appointments on a mapping user interface including time, location, and/or transportation information associated with the appointments.

According to one embodiment, a method comprises determining one or more flexible parameters of at least one flexible appointment based, at least in part, on one or more fixed parameters of at least one fixed appointment. The method also comprises causing, at least in part, a presentation of at least one mapping user interface depicting the one or more flexible parameters, the at least one flexible appointment, the one or more fixed parameters, the at least one fixed appointment, or a combination thereof, wherein the one or more flexible parameters, the one or more fixed parameters, or a combination thereof include, at least in part, one or more location parameters, one or more time parameters, one or more transportation parameters, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine one or more flexible parameters of at least one flexible appointment based, at least in part, on one or more fixed parameters of at least one fixed appointment. The apparatus also causes, at least in part, a presentation of at least one mapping user interface depicting the one or more flexible parameters, the at least one flexible appointment, the one or more fixed parameters, the at least one fixed appointment, or a combination thereof, wherein the one or more flexible parameters, the one or more fixed parameters, or a combination thereof include, at least in part, one or more location parameters, one or more time parameters, one or more transportation parameters, or a combination thereof.

According to another embodiment, a computer-readable storage medium carries one or more sequences of one or more instructions which, when executed by one or more processors, cause, at least in part, an apparatus to determine one or more flexible parameters of at least one flexible appointment based, at least in part, on one or more fixed parameters of at least one fixed appointment. The apparatus also causes, at least in part, a presentation of at least one mapping user interface depicting the one or more flexible parameters, the at least one flexible appointment, the one or more fixed parameters, the at least one fixed appointment, or a combination thereof, wherein the one or more flexible parameters, the one or more fixed parameters, or a combination thereof include, at least in part, one or more location parameters, one or more time parameters, one or more transportation parameters, or a combination thereof.

According to another embodiment, an apparatus comprises means for determining one or more flexible parameters of at least one flexible appointment based, at least in part, on one or more fixed parameters of at least one fixed appointment. The apparatus also comprises means for causing, at least in part, a presentation of at least one mapping user interface depicting the one or more flexible parameters, the at least one flexible appointment, the one or more fixed parameters, the at least one fixed appointment, or a combination thereof, wherein the one or more flexible parameters, the one or more fixed parameters, or a combination thereof include, at least in part, one or more location parameters, one or more time parameters, one or more transportation parameters, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of visualizing a flow of fixed and flexible daily calendar appointments on a mapping user interface including time, location, and/or transportation information associated with the appointments, according to one embodiment;

FIG. 2 is a diagram of the components of a mapping platform, according to one embodiment;

FIGS. 3-5 are flowcharts of processes for visualizing a flow of fixed and flexible daily calendar appointments on a mapping user interface including time, location, and/or transportation information associated with the appointments, according to one embodiment;

FIGS. 6A-6C are diagrams of an example use case depicting the utilization of the processes of FIGS. 3-5, according to various embodiments;

FIGS. 7A and 7B are diagrams of user interfaces utilized in the processes of FIGS. 3-5, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for visualizing a flow of fixed and flexible daily calendar appointments on a mapping user interface including time, location, and/or transportation information associated with the appointments are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

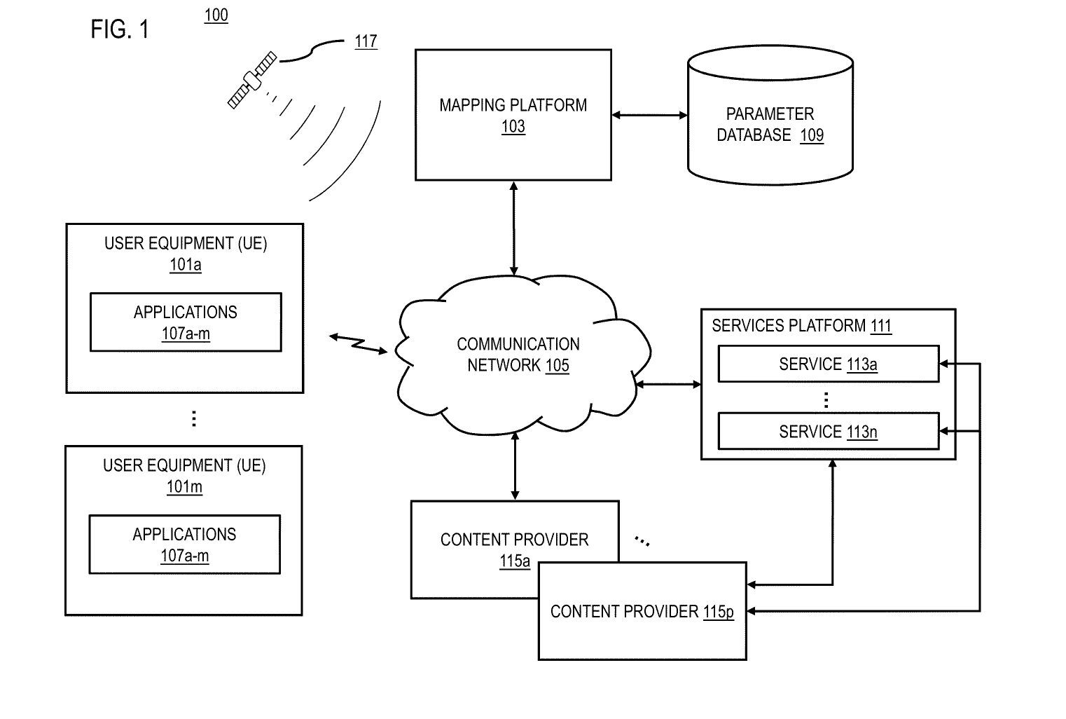

FIG. 1 is a diagram of a system capable of visualizing a flow of fixed and flexible daily calendar appointments on a mapping user interface including time, location, and/or transportation information associated with the appointments, according to one embodiment. As previously discussed, one area of interest among service providers and device manufacturers has been the development of calendar services that allow users of mobile devices (e.g., mobile phones and/or tablets) to organize upcoming tasks, appointments, responsibilities, etc. over a period of time (e.g., a day, a week, a month, etc.) and then have that information readily available for viewing on a mobile device. However, users are currently unable to intuitively determine how or when to get from one appointment to the next and/or what POIs are near a fixed appointment that may enable a user to accomplish an ad-hoc task (e.g., buying a present, meeting a friend for a cup of coffee, etc.). For example, many current calendar applications are purely time-driven and are therefore one-dimensional. In addition, many current calendar applications do not tell a user anything about where he or she will be at a given time (e.g., if there is a restaurant around where the user is going to go to a party).

To address this problem, a system 100 of FIG. 1 introduces the capability to visualize a flow of fixed and flexible daily calendar appointments on a mapping user interface including time, location, and/or transportation information associated with the appointments. As shown in FIG. 1, the system 100 comprises one or more user equipment (UE) 101a-101m (e.g., mobile phones and/or tablets) (also collectively referred to as UEs 101) having connectivity to a mapping platform 103 via a communication network 105. The UEs 101 also include or have access to one or more applications 107a-107m (also collectively referred to as applications 107). By way of example, the applications 107 include a mapping and/or navigation application, one or more organizational applications (e.g., a calendar application, a to-do list application, etc.), a wallet application, a weather-based application, an Internet browser (e.g., for viewing movie times, searching restaurant reviews, etc.), one or more social networking applications (e.g., for enabling location “check-ins”, status updates, etc.), communication applications, media applications, etc.

In one embodiment, the mapping platform 103 may include or be associated with at least one parameter database 109, which may exist in whole or in part within the mapping platform 103. In one example embodiment, the mapping platform 103 may exist in whole or in part within the UEs 101, or independently. The at least one parameter database 109 may include one or more location parameters (e.g., a location of a repeatedly visited coffee shop), one or more time parameters (e.g., the amount of time that it generally takes a user to walk one mile), one or more transportation parameters (e.g., one or more bus routes), or a combination thereof. The parameter database 109 may also include one or more formulas for determining the at least one time to travel between one or more appointments, the at least one recommended departure time, or a combination thereof as well one or more optimization strategies for determining the shortest route, the quickest route, the least expensive route, or a combination thereof between appointments.

The UEs 101 are also connected to a services platform 111 via the communication network 105. In one embodiment, the services platform 111 includes one or more services 113a-113n (also collectively referred to as services 113). The services 113 may include a wide variety of services such as content provisioning services for one or more of the applications 107. By way of example, the services 113 may include mapping and/or navigation services, transportation-based services (e.g., schedules and/or timetables), location-based services (e.g., traffic updates), weather-based services, social networking services, financial services, etc. In one embodiment, the UEs 101, the services platform 111, and the services 113 also have connectivity to one or more content providers 115a-115p (also collectively referred to as content providers 115). The content providers 115 also may provision a wide variety of content (e.g., maps, navigation routes, POI information, etc.) to the components of the system 100.

In certain embodiments, the applications 107 (e.g., a mapping and/or navigation application) may utilize one or more location-based technologies (e.g., global positioning system (GPS), cellular triangulation, Assisted GPS (A-GPS), etc.) to make a request to one or more services 113 for location-based data (e.g., mapping and/or navigation information, traffic information, social networking information, etc.) based on a position relative to a UE 101. For example, a UE 101 may include a GPS receiver to obtain geographic coordinates from the satellites 117 to determine its current location.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101 can support any type of interface to the user (such as “wearable” circuitry, etc.).

In one embodiment, the system 100 determines context information associated with at least one device (e.g., a mobile phone or a tablet) depicting at least one mapping user interface, wherein at least one fixed appointment (e.g., a hairdresser appointment) is based, at least in part, on the context information. By way of example, the context information may include, at least in part, a current day and/or time, a future day and/or time, or a combination thereof that a user wants to plan or to review (i.e., that day has already been planned). By way of further example, the at least one fixed appointment may be based, at least in part, on a fixed location, a fixed time, and/or a fixed contextual criteria (e.g., during the night). More specifically, in one example use case, the system 100 can determine that it is Saturday morning from the satellites 117, for example, and that there are three fixed appointments scheduled for that day based, at least in part, on or more entries in a calendar application 107 (e.g., a hairdresser appointment 2:00-3:00 p.m., a movie appointment 8:00-9:30 p.m., and a birthday party at a fixed location).

In one embodiment, the system 100 determines one or more flexible parameters of at least one flexible appointment based, at least in part, on one or more fixed parameters of at least one fixed appointment. In particular, the user may want to know how he or she will get from one location to another (e.g., from his or her home to the hairdresser), when he or she will arrive at a location, and/or when he or she should leave from one location to get to another. By way of example, the one or more flexible parameters, the one or more fixed parameters, or a combination thereof include, at least in part, one or more location parameters (e.g., an address, a distance, etc.), one or more time parameters (e.g., a time of an appointment, a time to get from one appointment to the next, a time of the day, etc.), one or more transportation parameters (e.g., the different means of available transportation, the average speed associated with the available means of transportation on a particular day and/or at a particular time, the average cost associated with a particular means of transportation, etc.), or a combination thereof. As previously discussed, in one example use case, the system 100 can determine that a user has three fixed appointments scheduled on a particular day (e.g., a hairdresser appointment at 2:00 p.m., a movie at 8:00 p.m., and a birthday party without a starting time) based, at least in part, on one or more entries in a calendar application 107, for example. In the same example use case, the system 100 can also determine that the user has two flexible appointments (e.g., buying a birthday present and going shopping), based, at least in part, on one or more entries in a to-do list application 107, for example. As a result, in one embodiment, the system 100 can determine the one or more flexible parameters based, at least in part, on which one of the one or more flexible parameters will enable the user to arrive at the at least one fixed appointment on time and also accomplish the at least one flexible appointment in a reasonable manner (e g, minimizing travel time, distance, and/or expense).

In one or more embodiments, the system 100 determines at least one flow, at least one other flow, or a combination thereof of the at least one fixed appointment, the at least one flexible appointment, or a combination thereof based, at least in part, on at least one interaction with the at least one mapping user interface. By way of example, a user may know that there is a shopping center near the location of the fixed hairdresser appointment and that he or she wants to accomplish the flexible shopping appointment after the fixed hairdresser appointment. In one embodiment, the system 100 can then determine the at least one flow or order based, at least in part, on the user moving (e.g., “dragging and dropping”) an interactive interface element associated with the flexible shopping appointment (e.g., a dialogue box labeled “shopping”) to the location of the shopping center on the at least one mapping user interface. In the same example use case, the user may also know that there is a gift shop near the fixed movie appointment and that he or she wants to go to the gift shop before the movie. Accordingly, the system 100 can further determine the at least one flow based, at least in part, on the user dragging and dropping, for example, an interactive dialogue box labeled “buy present,” for example, to the location of the gift shop on the at least one mapping user interface. In one embodiment, the system 100 can also determine at least one other flow based, at least in part, on one or more optimization strategies for traveling between at least two locations (e.g., the shortest route, the quickest route, the least expensive route, etc.) and cause, at least in part, a presentation of the one or more flexible parameters that can enable a user to accomplish the one or more optimization strategies. (e.g., by recommending that the user move the at least one flexible appointment to another location, take a different means of transportation, etc.).

In one embodiment, the system 100 determines at least one travel time, at least one recommend departure time, or a combination thereof based, at least in part, on the one or more flexible parameters. For example, in the example use case discussed above, the system 100 can determine that by walking, the user can reasonably get from the fixed hairdresser appointment to the flexible shopping appointment in approximately fifteen minutes. As a result, if the user leaves the hairdresser at the end of his or her appointment (e.g., at 3:00 p.m.), he or she should reasonably be able to arrive at the shopping complex by 3:15 p.m. Likewise, in one embodiment, the system 100 can determine that if the user wants to take public transportation (e.g., a bus, a subway, etc.) between the flexible gift shop appointment and the fixed movie appointment, the user will need to leave the gift shop by 7:40 p.m. to arrive at the movies on time.

In one embodiment, if a user is unfamiliar with the area around the at least one fixed appointment (e.g., the fixed hairdresser appointment), the system 100 can determine one or more POIs proximate to the at least one fixed appointment in the at least one mapping user interface based, at least in part, on the at least one flexible appointment, the at least one fixed appointment, or a combination thereof. For example, if the user wants to go shopping before or after the fixed hairdresser appointment, but does not know the location of any shops in that area, the system 100 can cause, at least in part, a presentation of one or more relevant POIs proximate to the fixed hairdresser appointment, which the user can then choose among (e.g., by dragging and dropping the shopping dialogue box on top of a particular POI symbol on the at least one mapping user interface). Similarly, if the user wants to buy a birthday present before or after the fixed movie appointment, but does not know the location of any gift shops in that area, the system 100 can cause, at least in part, a presentation of one or more relevant POIs near the fixed movie appointment, which the user can then select from.

In one or more embodiments, the system 100 causes, at least in part, a presentation of the at least one mapping user interface depicting the one or more flexible parameters, the at least one flexible appointment, the one or more fixed parameters, the at least one fixed appointment, or a combination thereof. More specifically, the system 100 can cause, at least in part, a presentation of the at least one fixed appointment and the at least one flexible appointment in terms of location, time, and the relationship between the appointments using various dialogue boxes and directional arrows, for example. By way of example, the system 100 can cause, at least in part, a presentation of a dialogue box labeled “hairdresser 2:00-3:00 p.m.,” on the location of the hairdresser on the at least one mapping user interface and two dialogue boxes labeled “shopping” and “buy present,” respectively, to the side of the at least one mapping user interface.

In one embodiment, once the system 100 determines that a user wants to take public transportation (e.g., a bus) to the fixed hairdresser appointment (e.g., by determining that the user has dragged and dropped an interactive bus glyph between a dialogue box representing “home” and the hairdresser dialogue box), the system 100 can cause, at least in part, a presentation on the at least one mapping user interface of a dialogue box that shows the user that he or she will have to leave his or her house by 1:30 p.m. to arrive at the fixed hairdresser appointment on time (e.g., at 2:00 p.m.). Thereafter, in one embodiment, the system 100 causes, at least in part, a presentation of a dialogue box labeled “shopping arrive at 3:15 p.m.,” for example, on the location of the shopping center on the at least one mapping user interface so that the user knows based, at least in part, on his or her selection of the one or more flexible parameters (e.g., walking) that it will take him or her approximately fifteen minutes to walk from the fixed hairdresser appointment to the flexible shopping appointment.

In the same example use case, the system 100 determines that the user wants to drive home from the shopping center (e.g., because the user may be carrying a number of bags) based, at least in part, on the user dragging and dropping, for example, an interactive car glyph on the at least one mapping user interface between the dialogue boxes of the flexible shopping appointment and the fixed home location. Consequently, in one embodiment, the system 100 causes, at least in part, a presentation on the at least one mapping user interface of a dialogue box that shows the user that by driving, it will take the user approximately fifteen minutes to get home. In one embodiment, the system 100 determines that the user has scheduled approximately 30 minutes to look for a gift at the gift shop (e.g., based on an entry in the to-do list application 107) and that the user wants to travel there by public transit (e.g., a bus) based, at least in part, on the user dragging and dropping, for example, an interactive bus glyph on the at least one mapping user interface between the dialogue boxes of the fixed location home and the flexible gift shop appointments. As a result, in one embodiment, the system 100 causes, at least in part, a presentation on the at least one mapping user interface of a dialogue box that shows the user that he or she should leave his or her house by 6:30 p.m. to be at the gift shop by 7:10 p.m. by bus, for example.

Continuing with this example use case, the system 100 determines that after the movie the user will go by public transportation (e.g., a bus) to the fixed birthday party appointment based, at least in part, on the user dragging and dropping, for example, an interactive bus glyph on the at least one mapping user interface between the dialogue boxes of the fixed movie appointment and the fixed birthday party appointment. Subsequently, the system 100 causes, at least in part, a presentation of a dialogue box labeled “arrive around 10:15 p.m.,” for example, that informs the user that he or she should arrive at the fixed birthday party appointment at that time by taking a bus. Thereafter, the system 100 can determine that the user wants to travel home by car, for example, based, at least in part on the user dragging and dropping, for example, an interactive car glyph on the at least one mapping user interface between the dialogue boxes of the fixed birthday party appointment and the fixed location home. Consequently, in one embodiment, the system 100 causes, at least in part, a presentation on the at least one mapping user interface of a dialogue box labeled “takes 35 minutes,” for example, that shows the user how long the trip home will take by car.

In one or more embodiments, the system 100 determines at least one change of the one or more time parameters, the one or more location parameters, the one or more transportation parameters, or a combination thereof in substantially real-time, periodically, according to a schedule, on demand, or a combination thereof. By way of example, in the example use case discussed above, if the user changes his or her mind and decides that he or she wants to take public transportation home from the birthday party instead of driving a car, then system 100 can cause, at least in part, at least one update of the time that the system 100 is presenting to the user in the dialogue box (i.e., the system 100 recalculates the amount of time needed for the user to get home). In another example use case, the system 100 can determine (e.g., based on GPS associated with the at least one device) that the user is still at the fixed hairdresser appointment after the end of the appointment (e.g., after 3:00 p.m.). As a result, the system 100 can cause, at least in part, at least one update of the presentation of the time in the dialogue box of the flexible shopping appointment so that the user will know that he or she will now arrive at the shopping center by walking at 3:30 p.m. instead of 3:15 p.m., for example.

In certain embodiments, the system 100 determines at least one interaction with the at least one user interface of the at least one device depicting one or more time frames. By way of example, the at least one other user interface may be a calendar application 107 depicting a user's agenda for a particular day and the calendar application 107 may include at least one map related interface element (e.g., a “map it” button) connected to the at least one mapping user interface. In one embodiment, if the system 100 determines a selection of the map related interface element (e.g., based on a click, a long press, a swipe, etc.), the system 100 can cause, at least in part, a transition from the calendar application 107, for example, to the at least one mapping user interface. More specifically, in one embodiment, it is contemplated that the system 100 can cause, at least in part, a presentation showing a user his or her entire day on the at least one mapping user interface and enable the user to pan the map, for example, to see the details of each part of his or her day. In addition, in one embodiment, the system 100 can cause, at least in part, a presentation of the part of the at least one mapping user interface that corresponds to the current time of day, for example.

In one embodiment, the system 100 determines free-time information based, at least in part, on the one or more fixed parameters, the at least one fixed appointment, or a combination thereof, wherein the one or more flexible parameters, the at least one flexible appointment, or a combination thereof is further based, at least in part, on the free-time information. More specifically, in one example use case, the system 100 can determine that a user has a fixed dentist appointment at 5:55 p.m., for example, and a fixed birthday party appointment at 8:00 p.m., for example. As a result, the system 100 can determine that the user has approximately two hours of free-time to accomplish one or more flexible appointments, one or more ad-hoc tasks, or a combination thereof (e.g., a task listed on a to-do list application 107). In addition, in one embodiment, the system 100 can cause, at least in part, a presentation of one or more POIs corresponding to one or more potential flexible appointments in the area around the fixed dentist appointment and/or the area between the fixed dentist appointment and the fixed birthday party appointment. Further, in one embodiment, the system 100 can determine based, at least in part, on the amount of free time (e.g., two hours) and the current location of the user that the user can accomplish three of the potential flexible appointments. Thereafter, the system 100 can cause, at least in part, a presentation of a flow of the three flexible appointments based, at least in part, on one or more flexible parameters (e.g., available means of transportation). Moreover, in one embodiment, the system 100 can show the user that by taking public transportation instead of walking, for example, the user can accomplish more flexible appointments or vice-versa depending on the particular context (e.g., during rush hour).

In one or more embodiments, the system 100 can determine other context information associated with the at least one device, at least one user of the at least one device, or a combination thereof, wherein the one or more flexible parameters, the at least one flexible appointment, or a combination thereof is further based, at least in part, on the other context information. By way of example, if the system 100 determines that a user has purchased a large number of items at a shop (e.g., based on a wallet application 107) and that those items are heavy and/or unwieldy (e.g., items purchased from a lumber yard), then the system 100 can cause, at least in part, the presentation of the route home in the at least one mapping user interface based, at least in part, on traveling by a car rather than by taking public transportation or walking. Similarly, if the system 100 determines that it is raining (e.g., based on a weather-based application 107), then the system 100 can cause, at least in part, the presentation of the route home based, at least in part, on traveling by a car or public transportation rather than by walking.

In one embodiment, the system 100 determines at least one other flexible appointment, at least one other fixed appointment, or a combination thereof associated with one or more users (e.g., a friend, a colleague, a family member, etc.), wherein the presentation is further based, at least in part, on the at least one other flexible appointment, the at least one other fixed appointment, or a combination thereof. By way of example, the system 100 can determine the at least one other flexible appointment, the at least one other fixed appointment, or a combination thereof based, at least in part, on a location “check-in” on a social networking service 113, one or more shared locations, one or more shared appointments, one or more shared to-do lists, or a combination thereof. In one embodiment, the system 100 can then cause, at least in part, a presentation of the at least one other flexible appointment (e.g., get coffee) on the at least one mapping user interface. In particular, the at least one other flexible appointment may be based on one or more time parameters (e.g., 3:00-4:30 p.m.), one or more location parameters (e.g., downtown, on Main Street, near the park, etc.), or a combination thereof. If the one or more time parameters and/or the one or more location parameters of the at least one other flexible appointment match with the one or more flexible parameters of a user (e.g., a time, a location, an activity, etc.), then the user can move his or her at least one flexible appointment to the location of the at least one other flexible appointment on the at least one mapping user interface (e.g., by dragging and dropping). As a result, in one embodiment, the system 100 can cause, at least in part, a presentation showing the user how he or she can get to the at least one other flexible appointment and how long it will take to get there based, at least in part, on one or more transportation parameters. In one embodiment, the system 100 can also share the one or more flexible parameters (e.g., a travel time) between the user and the one or more other users so that each respective user is aware of the other's progress towards the coffee shop, for example, in substantially real-time, for example.

By way of example, the UEs 101, the mapping platform 103, the applications 107, the at least one parameter database 109, the services platform 111, the services 113, the content providers 115, and the satellites 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

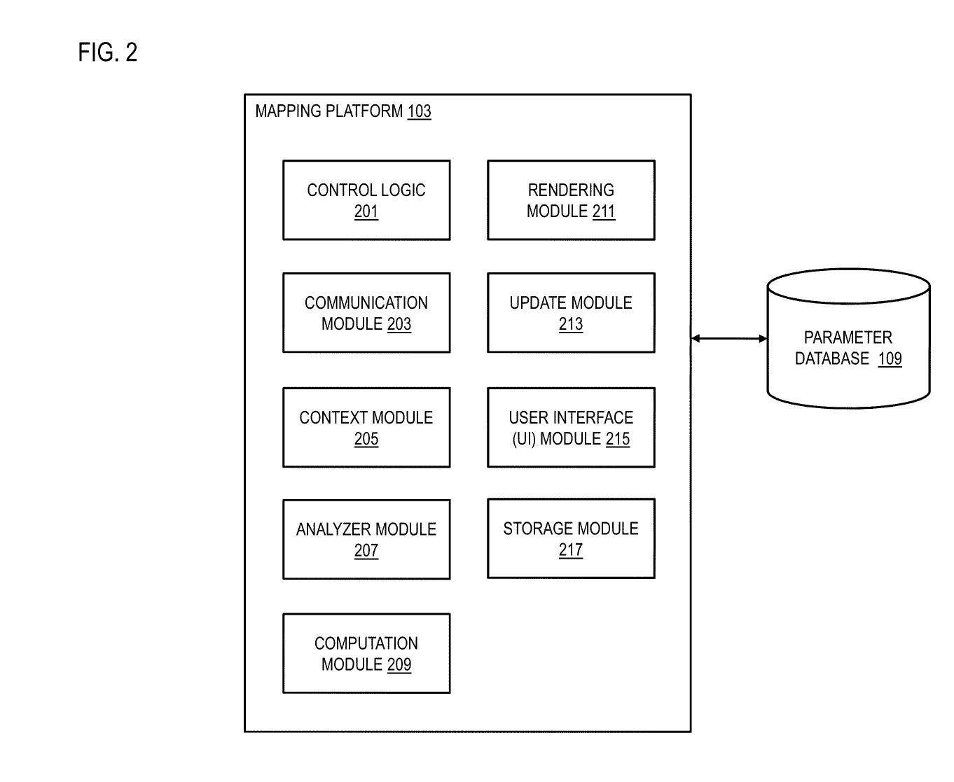

FIG. 2 is a diagram of the components of a mapping platform 103, according to one embodiment. By way of example, the mapping platform 103 includes one or more components for visualizing a flow of fixed and flexible daily calendar appointments on a mapping user interface including time, location, and/or transportation information associated with the appointments. It is contemplated that the functions of these components may be combined in one or more components or performed by other components of equivalent functionality. In this embodiment, the mapping platform 103 includes a control logic 201, a communication module 203, a context module 205, an analyzer module 207, a computation module 209, a rendering module 211, an update module 213, a user interface (UI) module 215, and a storage module 217.

In one embodiment, the control logic 201 oversees tasks, including tasks performed by the communication module 203, the context module 205, the analyzer module 207, the computation module 209, the rendering module 211, the update module 213, the UI module 215, and the storage module 217. For example, although the other modules may perform the actual task, the control logic 201 may determine when and how those tasks are performed or otherwise direct the other modules to perform the task.

In one embodiment, the communication module 203 is used for communication between the UEs 101, the mapping platform 103, the applications 107, the at least one parameter database 109, the services platform 111, the services 113, the content providers 115, and the satellites 117. The communication module 203 may also be used to communicate commands, requests, data, etc. The communication module 203 may also be used to determine at least one other flexible appointment, at least one other fixed appointment, or a combination thereof associated with one or more other users (e.g., a social networking friend). By way of example, the communication module 203 may determine the at least one other flexible appointment, at least one other fixed appointment, or a combination thereof based on a location “check-in” on a social networking service, one or more shared locations, one or more shared appointments, one or more shared to-do lists, or a combination thereof.

In one or more embodiments, the context module 205 is used to determine context information (e.g., a day of the week, a time of the day, etc.) associated with at least one device depicting the at least one mapping user interface (e.g., a mobile phone and/or a tablet). For example, the context module 205, in connection with the communication 203, can determine the context information from the satellites 117. The context module 205 may also be used to determine other context information associated with the at least one device, at least one user of the at least one device, or a combination thereof. For example, the context module 205 can determine from a wallet application 107, for example, that the at least one user has purchased a number of items at a store and that the one or more items may be heavy and/or unwieldy (e.g., items purchased at a lumber yard).

The analyzer module 207 in certain embodiments is used to determine one or more flexible parameters of at least one flexible appointment based, at least in part, on one or more fixed parameters of at least one fixed appointment. By way of example, the analyzer module 207 can determine the one or more fixed parameters (e.g., a geocoded address) and/or the at least one fixed appointment (e.g., a hairdresser appointment) based on one or more entries in a calendar application 107, for example. By way of further example, the analyzer module 207 can determine the at least one flexible appointment based on one or more entries in a to-do list application 107, for example. In one embodiment, the analyzer module 207 can then determine the one or more flexible parameters of the at least one flexible appointment (e.g., time, location, transportation, etc.) based, at least in part, on one or more parameters (e.g., a transportation parameter) that enables a user to arrive at the at least one fixed appointment on time and also enables the user to accomplish the at least one flexible appointment in a reasonably convenient manner.

In one embodiment, the analyzer module 207, in connection with the UI module 215, may also be used to determine at least one flow, at least one other flow, or a combination thereof of the at least one fixed appointment, the at least one flexible appointment, or a combination thereof based, at least in part, on at least one interaction with the at least one mapping user interface. By way of example, after the UI module 215 determines a location of at least one flexible appointment relative to the at least one fixed appointment on the at least one mapping user interface (i.e., the at least one flow), the analyzer module 207 can determine at least one other flow based, at least in part, on one or more optimization strategies between at least two locations (e.g., the shortest route, the quickest route, the least expensive route, or a combination thereof) stored in the at least one parameter database 109, for example. The analyzer module 207 also may be used to determine one or more POIs proximate to the at least one fixed appointment in the at least one mapping user interface based, at least in part, on the at least one flexible appointment, the at least one fixed appointment, or a combination thereof. For example, the analyzer module 207 can determine the one or more POIs based, at least in part, on a location-based service 111, for example.

In one or more embodiments, the computation module 209 is used to determine at least one travel time, at least one recommended departure time, or a combination thereof based, at least in part, on the one or more flexible parameters. In particular, the one or more flexible parameters include, at least in part, one or more location parameters, one or more time parameters, one or more transportation parameters, or a combination thereof. By way of example, the computation module 209 can determine that if a user is taking a bus from the flexible gift shop appointment, for example, and wants to get to the fixed movie appointment at 8:00 p.m., the user will have to leave the gift shop by 7:40 p.m. The computation module 209, in connection with the analyzer module 207, also may be used to determine free-time information based, at least in part, on the one or more fixed parameters, the at least one fixed appointment, or a combination thereof. For example, once the analyzer module 207 determines that a user has a fixed dentist appointment at 5:55 p.m., for example, and a fixed birthday party at 8:00 p.m., for example, the computation module 209 can determine that the user has approximately two hours of free time to complete one or more flexible appointments. Moreover, if the analyzer module 207 determines that the user has more than one flexible appointment listed in a to-do list application 107, for example, the computation module 209 can determine how much time each flexible appointment will reasonably take (e.g., based on a user history) and can then determine how many of the one or more flexible appointments the user can reasonably accomplish based, at least in part, on the one or more flexible parameters.

The rendering module 211 in certain embodiments is used to cause, at least in part, a presentation of at least one mapping user interface depicting the one or more flexible parameters, the at least one flexible appointment, the one or more fixed parameters, the at least one fixed appointment, or a combination thereof. In particular, the rendering module 211 can present the at least one fixed appointment and the at least one flexible appointment in terms of location, time, the relationship between appointments, or a combination thereof. For example, the rendering module 211 can render a dialogue box, for example, depicting the location of the fixed movie appointment (i.e., the box is located on the location of the appointment) and the time of the particular movie (e.g., “movie 8:00-9:30 p.m.” is rendered inside of the box). Similarly, the rendering module 211 can render an interactive dialogue box (i.e., it can be moved and/or modified on the at least one mapping user interface) showing the location of the gift shop and the time at which the user must leave the gift shop (e.g., “leave at 7:40 p.m.” is rendered inside of the box). The rendering module can also present one or more representations of one or more means of transportation (e.g., a bus glyph, a car glyph, a walking glyph, etc.) between the at least one flexible appointment and the at least one fixed appointment so that the user knows that he or she must leave the gift shop by 7:40 p.m. to get to the movies on time based on taking a bus.

In one embodiment, the update module 213 is used to determine at least one change of the one or more time parameters, the one or more location parameters, the one or more transportation parameters, or a combination thereof in substantially real-time, periodically, according to a schedule (e.g., a schedule stored in the at least one parameter database 109), on demand, or a combination thereof. By way of example, if a user decides to change the intended mode of transportation between the flexible gift shop appointment and the fixed movie appointment (e.g., taking a car instead of the bus), the update module 213 can recalculate the amount of time the trip will take as well as the recommended departure time so that the user can make it to the movies on time.

In one or more embodiments, the UI module 215 is used to determine at least one interaction with the at least one other user interface depicting one or more time frames (e.g., a click, a long press, a swipe, etc.). As previously discussed, the UI module 215 may also be used to determine at least one interaction with the at least one mapping user interface (e.g., moving at least one flexible appointment near at least one fixed appointment).

In one embodiment, the storage module 217 is used to manage the storage of the one or more location parameters (e.g., a location of a repeatedly visited coffee shop), one or more time parameters (e.g., the amount of time that it generally takes a user to walk one mile), one or more transportation parameters (e.g., one or more bus routes), or a combination thereof in the at least one parameter database 109. The storage module 217 may also be used to manage the storage of the one or more formulas for determining the at least one time to travel between the one or more appointments, the at least one recommended departure time, or a combination thereof as well the one or more optimization strategies for determining the shortest route, the fastest route, the least expensive route, or a combination thereof between appointments also stored in the at least one parameter database 109.

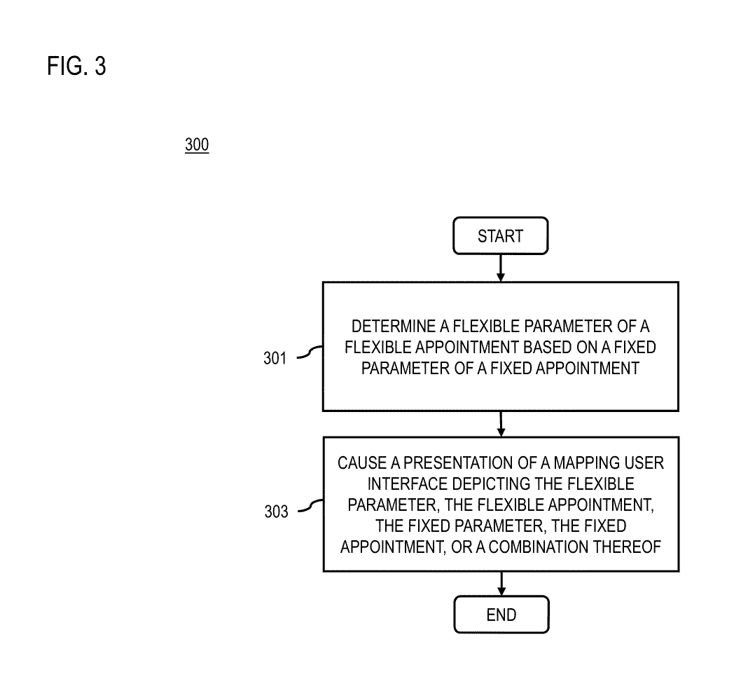

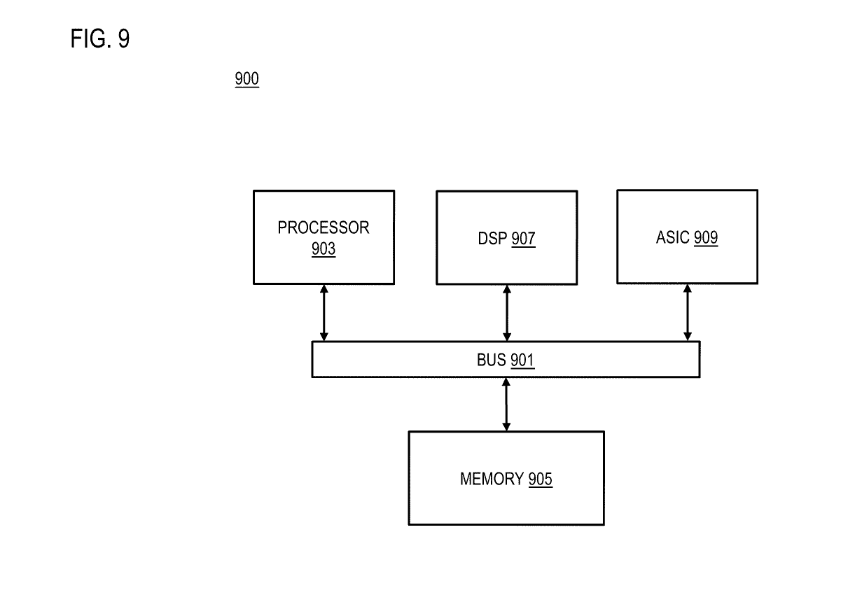

FIGS. 3-5 are flowcharts of processes for visualizing a flow of fixed and flexible daily calendar appointments on a mapping user interface including time, location, and/or transportation information associated with the appointments, according to one embodiment. In one embodiment, the mapping platform 103 performs the process 300 and is implemented in, for instance, a chip set including a processor and a memory as shown in FIG. 9. In step 301, the mapping platform 103 determines one or more flexible parameters of at least one flexible appointment based, at least in part, on one or more fixed parameters of at least one fixed appointment. By way of example, the one or more flexible parameters, the one or more fixed parameters, or a combination thereof include, at least in part, one or more location parameters (e.g., an address, a distance, etc.), one or more time parameters (e.g., a time of an appointment, a time to get from one appointment to the next, a time of day, etc.), one or more transportation parameters (e.g., the different means of available transportation, the average speed associated with the available means of transportation on a particular day and/or at a particular time, the average cost associated with a particular means of transportation, etc.), or a combination thereof. By way of further example, the at least one fixed appointment may be based, at least in part, on a fixed location, a fixed time, and/or a fixed contextual criteria (e.g., during the night) whereas the at least one flexible appointment may be based, at least in part, on one or more flexible locations, one or more flexible times, and/or one or more flexible contextual criteria (e.g., during the day or night).

In one example use case, the mapping platform 103 can determine that a user has three fixed appointments scheduled on a particular day (e.g., a hairdresser appointment at 2:00 p.m., a movie at 8:00 p.m., and a birthday party without a starting time) based, at least in part, on one or more entries in a calendar application 107, for example. In the same example use case, the mapping platform 103 can also determine that the user has two flexible appointments (e.g., buying a birthday present and going shopping) based, at least in part, on one or more entries in a to-do list application 107, for example. Consequently, in one embodiment, the mapping platform 103 can determine the one or more flexible parameters, the at least one flexible appointment, or a combination thereof based, at least in part, on which one of the one or more flexible parameters will enable the user to arrive at the at least one fixed appointment on time and also accomplish the at least one flexible appointment in a reasonable manner (e.g., minimizing travel time, distance, and/or expense).

In step 303, the mapping platform 103 causes, at least in part, a presentation of at least one mapping user interface depicting the one or more flexible parameters, the at least one flexible appointment, the one or more fixed parameters, the at least one fixed appointment, or a combination thereof, wherein the one or more flexible parameters, the one or more fixed parameters, or a combination thereof include, at least in part, one or more location parameters, one or more time parameters, one or more transportation parameters, or a combination thereof. In particular, the mapping platform 103 can cause, at least in part, a presentation of the at least one fixed appointment and the at least one flexible appointment in terms of location, time, the relationship between the appointments, or a combination thereof using various dialogue boxes and directional arrows, for example.

By way of example, the mapping platform 103 can cause, at least in part, a presentation of a dialogue box labeled “hairdresser 2:00-3:00 p.m.,” for example, on the location of the hairdresser on the at least one mapping user interface and two dialogue boxes labeled “shopping” and “buy present,” respectively, to the side of the at least one mapping user interface. Likewise, if the mapping platform 103 determines that a user wants to take public transportation (e.g., a bus) to the fixed hairdresser appointment (e.g., by determining that the user has dragged and dropped an interactive bus glyph between a dialogue box representing “home” and the hairdresser dialogue box), the mapping platform 103 can cause, at least in part, a presentation on the at least one mapping user interface of a dialogue box that shows the user that he or she will have to leave his or her house by 1:30 p.m. to arrive at the fixed hairdresser appointment on time (e.g., at 2:00 p.m.). Thereafter, in one embodiment, the mapping platform 103 causes, at least in part, a presentation of a dialogue box labeled “shopping arrive at 3:15 p.m.,” for example, on the location of the shopping center on the at least one mapping user interface so that the user knows based, at least in part, on his or her selection of the one or more flexible parameters (e.g., walking) that it will take the user approximately 15 minutes to walk from the fixed hairdresser appointment to the flexible shopping appointment.

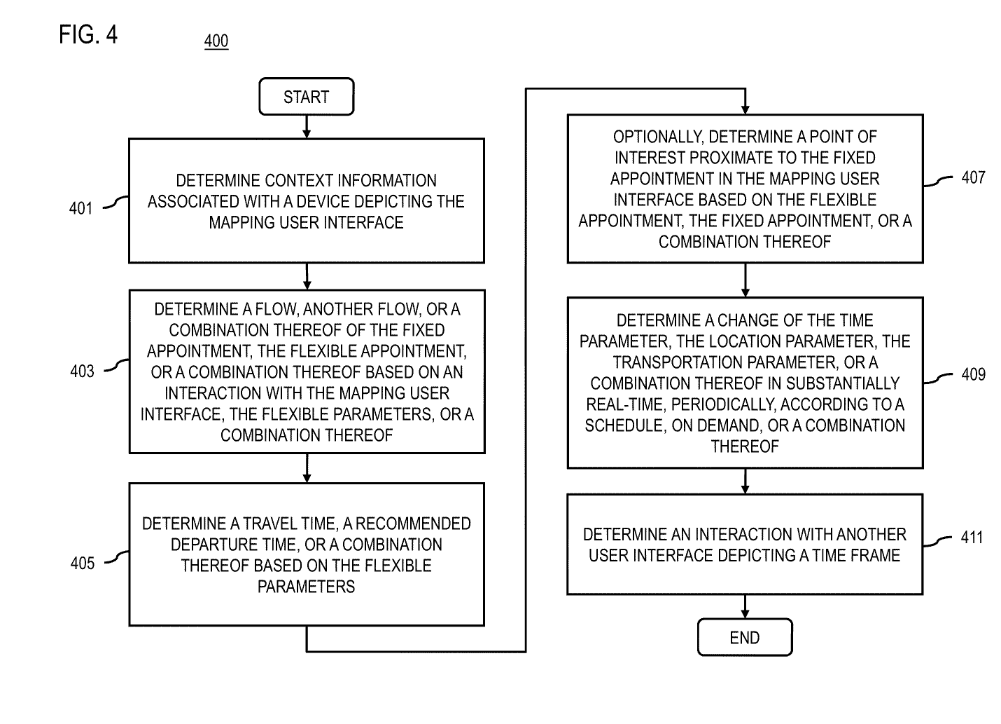

FIG. 4 depicts a process 400 of determining the presentation of the at least one mapping user interface depicting the one or more flexible parameters, the one at least one flexible appointment, the one or more fixed parameters, the at least one fixed appointment, or a combination thereof. In one embodiment, the mapping platform 103 performs the process 400 and is implemented in, for instance, a chip set including a processor and a memory as shown in FIG. 9. In step 401, the mapping platform 103 determines context information associated with at least one device depicting the at least one mapping user interface, wherein the at least one fixed appointment is based, at least in part, on the context information. By way of example, the context information may include, at least in part, a current day and/or time, a future day and/or time, or a combination thereof that a user wants to plan or to review (i.e., the day has already been planned). More specifically, in the example use case discussed above, the mapping platform 103 can determine that it is Saturday morning from the satellites 117, for example, and that a user has three fixed appointments scheduled for that day based, at least in part, on one or more entries in a calendar application 107, for example. For example, the system 100 determines that the user has a hairdresser appointment 2:00-3:00 p.m., a movie appointment 8:00-9:00 p.m., and a birthday party at a fixed location.

In step 403, the mapping platform 103 determines at least one flow, at least one other flow, or a combination thereof of the at least one fixed appointment, the at least one flexible appointment, or a combination thereof based, at least in part, on at least one interaction with the at least one mapping user interface, wherein the presentation is further based, at least in part, on the at least one flow, the at least one other flow, or a combination thereof. By way of example, a user may know that there is a shopping center near the location of the fixed hairdresser appointment and that he or she wants to accomplish the flexible shopping appointment after the fixed hairdresser appointment. In one embodiment, the mapping platform 103 can then determine the at least one flow or order based, at least in part, on the user dragging and dropping the dialogue box labeled “shopping” associated with the flexible shopping appointment to the location of the shopping center on the at least one mapping user interface. In the same example use case, the user may also know that there is a gift shop near the fixed movie appointment and that he or she wants to go to the gift shop before the movie. Accordingly, the mapping platform 103 can further determine the at least one flow based, at least in part, on the user dragging and dropping, for example, the dialogue box labeled “buy present,” to the location of the gift shop on the at least one mapping user interface. In certain embodiments, the mapping platform 103 can also determine at least one flow based, at least in part, on one or more optimization strategies for traveling between at least two locations (e.g., the shortest route, the quickest route, the least expensive route, or a combination thereof).

In step 405, the mapping platform 103 determines at least one travel time, at least one recommended departure time, or a combination thereof based, at least in part, on the one or more flexible parameters, wherein the presentation is further based, at least in part, on the at least one travel time, the at least one recommended departure time, or a combination thereof. By way of example, in the example use case discussed above, the mapping platform 103 can determine that by walking, the user can reasonably get from the fixed hairdresser appointment to the flexible shopping appointment in approximately fifteen minutes. As a result, if the user leaves the hairdresser at the end of his or her appointment (e.g., at 3:00 p.m.), then the user should reasonably be able to arrive at the shopping center by 3:15 p.m. Likewise, in one embodiment, the mapping platform 103 can determine that if the user wants to take public transportation (e.g., a bus, a subway, etc.) between the flexible gift shop appointment and the fixed movie appointment, the user will need to leave the gift shop by 7:40 p.m. to arrive at the movies on time.

In step 407, the mapping platform 103 optionally determines one or more points of interest proximate to the at least one fixed appointment in the at least one mapping user interface based, at least in part, on the at least one flexible appointment, the at least one fixed appointment, or a combination thereof, wherein the presentation is further based, at least in part, on the one or more points of interest. By way of example, if a user wants to go shopping before or after at least one fixed appointment (e.g., the fixed hairdresser appointment), but he or she does not know the location of any shops in that area, the mapping platform 103 can cause, at least in part, a presentation of one or more relevant POIs proximate to the at least one fixed appointment, which the user can then choose among (e.g., by dragging and dropping the shopping dialogue box on top of a particular POI symbol on the at least one mapping user interface).

In step 409, the mapping platform 103 determines at least one change of the one or more time parameters, the one or more location parameters, the one or more transportation parameters, or a combination thereof in substantially real-time, periodically, according to a schedule, on demand, or a combination thereof, wherein the one or more flexible parameters, the at least one flexible appointment, or a combination thereof is further based, at least in part, on the at least one change. By way of example, in the example use case discussed above, if the user changes his or her mind and decides that he or she wants to take public transportation home from the birthday party instead of driving a car, the mapping platform 103 can cause, at least in part, at least one update of the time that the mapping platform 103 is presenting to the user in the dialogue box (i.e., the mapping platform 103 recalculates the amount of time needed for the user to get home). In another example use case, the mapping platform 13 can determine (e.g., based on GPS associated with the at least one device) that the user is still at the fixed hairdresser appointment after the end of the scheduled appointment (e.g., after 3:00 p.m.). Consequently, the mapping platform 103 can cause, at least in part, at least one of update of the presentation of time in the dialogue box of the flexible shopping appointment so that the user will know that he or she will now arrive at the shopping center by walking at 3:30 p.m. instead of 3:15 p.m., for example.

In step 411, the mapping platform 103 determines at least one interaction with at least one other user interface of the at least one device depicting one or more time frames, wherein the presentation is further based, at least in part, on the at least one interaction. By way of example, the at least one other user interface may be a calendar application 107 depicting a user's agenda for a particular day and the calendar application 107 may include at least one map related interface element (e.g., a “map it” button) connected to the at least one mapping user interface. In one embodiment, if the mapping platform 103 determines a selection of the map related interface element (e.g., based on a click, a long press, a swipe, etc.), the mapping platform 103 can cause, at least in part, a transition from the calendar application 107, for example, to the at least one mapping user interface. In particular, in one embodiment, the mapping platform 103 can cause, at least in part, a presentation showing a user his or her entire day on the at least one mapping user interface and enable the user to pan the map, for example, to see the details of each part of his or her day. Moreover, in one embodiment, the mapping platform 103 can cause, at least in part, a presentation of the part of the at least one mapping user interface that corresponds to the current time of day, for example.

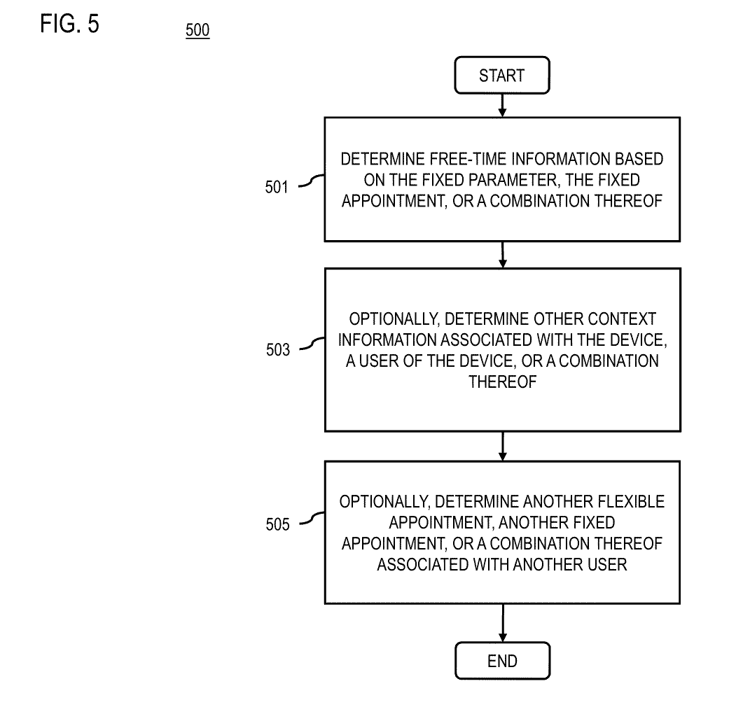

FIG. 5 depicts a process 500 of further determining the one or more flexible parameters, the one at least one flexible appointment, or a combination thereof. In one embodiment, the mapping platform 103 performs the process 500 and is implemented in, for instance, a chip set including a processor and a memory as shown in FIG. 9. In step 501, the mapping platform 103 determines free-time information based, at least in part, on the one or more fixed parameters, the at least one fixed appointment, or a combination thereof, wherein the one or more flexible parameters, the at least one flexible appointment, or a combination thereof is further based, at least in part, on the free-time information. In particular, in one example use case, the mapping platform 103 can determine that a user has a fixed dentist appointment at 5:55 p.m., for example, and a fixed birthday party appointment at 8:00 p.m., for example. Consequently, the mapping platform 103 can determine that the user has approximately two hours of free-time to accomplish one or more flexible appointments, one or more ad-hoc tasks, or a combination thereof (e.g., a task listed in a to-do list application 107). In addition, in one embodiment, the mapping platform 103 can cause, at least in part, a presentation of one or more POIs corresponding to one or more potential flexible appointments in the area around the fixed dentist appointment and/or the area between the fixed dentist appointment and the fixed birthday party appointment. Further, in one embodiment, the mapping platform 103 can determine based, at least in part, on the amount of free time (e.g., two hours) and the current location of the user that the user can accomplish three of the potential flexible appointments. Thereafter, the mapping platform 103 can cause, at least in part, a presentation of a flow of these three flexible appointments based, at least in part, on one or more flexible parameters (e.g., available means of transportation). Moreover, in one embodiment, the mapping platform 103 can show the user that by taking public transportation instead of walking, for example, the user can accomplish more flexible appointments or vice-versa depending on the particular context (e.g., during rush hour).

In step 503, the mapping platform 103 optionally determines other context information associated with the at least one device, at least one user of the at least one device, or a combination thereof, wherein the one or more flexible parameters, the at least one flexible appointment, or a combination thereof is further based, at least in part, on the other context information. In one example use case, if the mapping platform 103 determines that a user has purchased a large number of items (e.g., based on a wallet application 107) and that those items are heavy and/or unwieldy (e.g., items purchased from a lumber yard), the mapping platform 103 can cause, at least in part, the presentation of the route home in the at least one mapping user interface based on traveling by a car rather than by taking public transportation of walking. Likewise, if the mapping platform 103 determines that it is raining (e.g., based on a weather-based application 107), the mapping platform 103 can cause, at least in part, the presentation of the route home based on traveling by a car or public transportation rather than by walking.

In step 505, the mapping platform 103 optionally determines at least one other flexible appointment, at least one other fixed appointment, or a combination thereof associated with one or more other users, wherein the presentation is further based, at least in part, on the at least one other flexible appointment, the at least one other fixed appointment, or a combination thereof. By way of example, the mapping platform 103 can determine the at least one other flexible appointment, the at least one other fixed appointment, or a combination thereof based, at least in part, on a location “check-in” on a social networking service 113, one or more shared locations, one or more shared appointments, one or more shared to-do lists, or a combination thereof. In one embodiment, the mapping platform 103 can then cause, at least in part, a presentation of the at least one other flexible appointment (e.g., get coffee) on the at least one mapping user interface. More specifically, the at least one other flexible appointment may be based, at least in part, on one or more time parameters (e.g., 3:00-4:30 p.m.), one or more location parameters (e.g., downtown, on Main Street, near the park, etc.), or a combination thereof. If the one or more time parameters and/or the one or more location parameters of the at least one other flexible appointment match the one or more flexible parameters of a user (e.g., a time, a location, an activity, etc.), then the user can move his or her at least one flexible appointment to the location of the at least one other flexible appointment on the at least one mapping user interface (e.g., by dragging and dropping). Consequently, in one embodiment, the mapping platform 103 can then cause, at least in part, a presentation showing the user how he or she can get to the at least one other flexible appointment and how long it will take him or her to get there based, at least in part, on one or more transportation parameters. In one embodiment, the mapping platform 103 can also share the one or more flexible parameters (e.g., a travel time) between the user and the one or more users so that each respective user is aware of the other's progress towards the coffee shop, for example, in substantially real-time, for example.

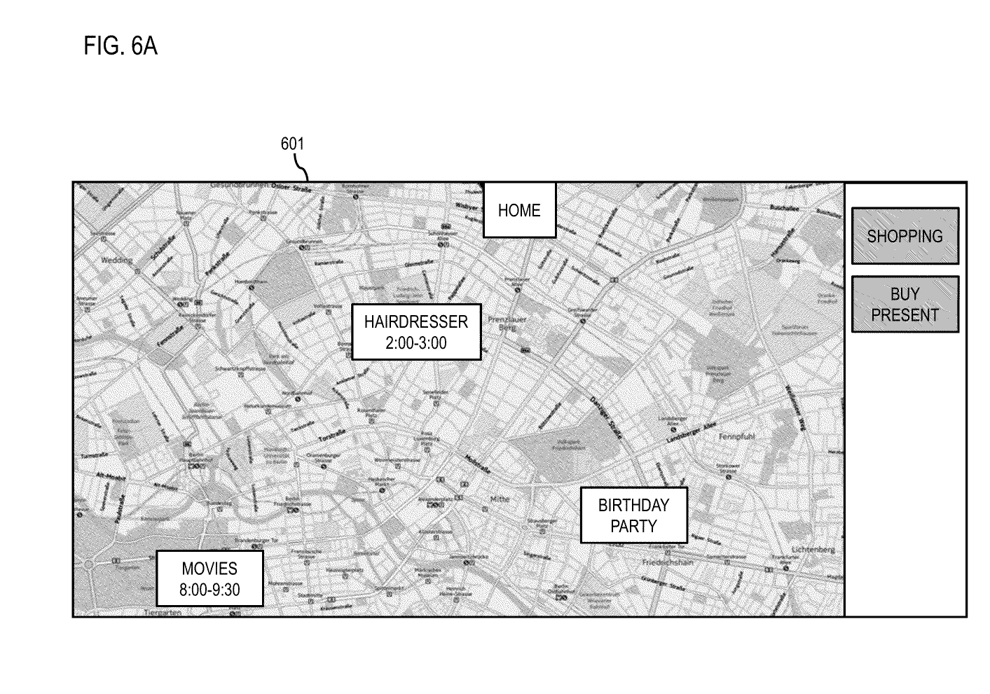

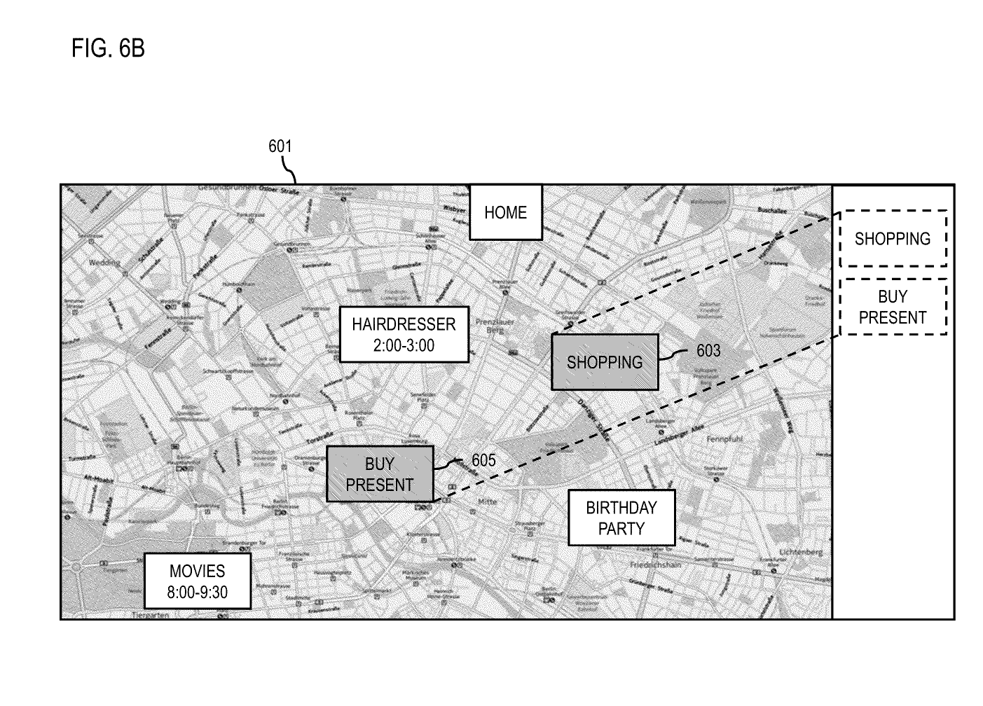

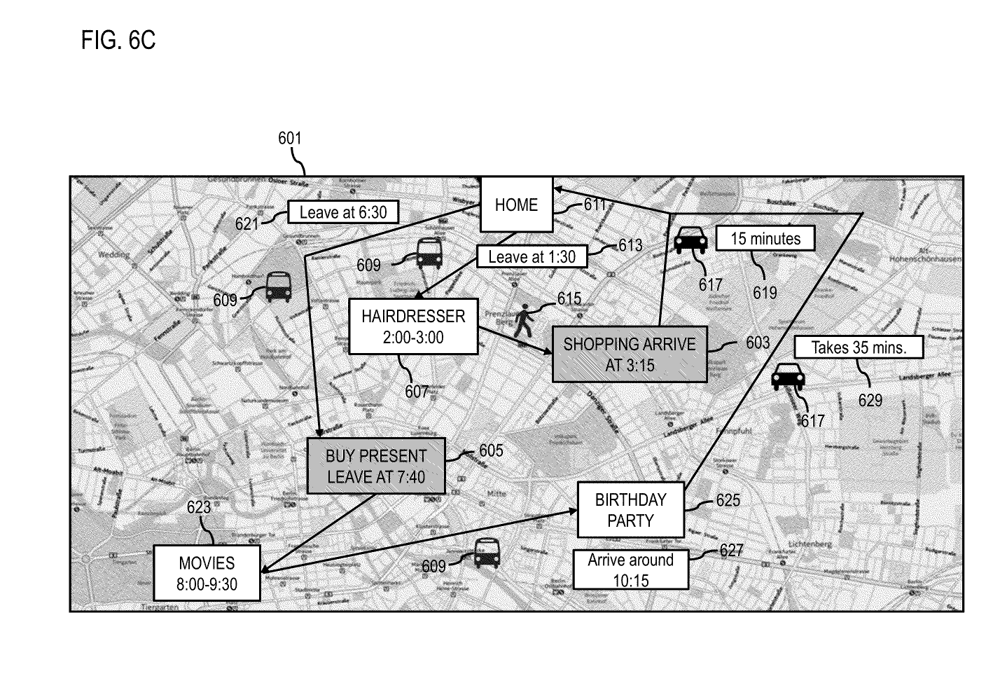

FIGS. 6A-6C are diagrams of an example use case depicting the utilization of the processes of FIGS. 3-5, according to various embodiments. As shown, FIG. 6A-6C depict an example use case where a user has three fixed appointments scheduled for a day and two flexible appointments that he or she also wants to accomplish on that day. As previously discussed, in one embodiment, the system 100 first determines context information associated with at least one device (e.g., a mobile phone or a tablet) depicting the mapping user interface 601, wherein at least one fixed appointment (e.g., a hairdresser appointment) is based, at least in part, on the context information. In this example use case, the system 100 can determine that it is Saturday morning from the satellites 117, for example, and that there are three fixed appointments scheduled for that day as depicted by the respective dialogue boxes based, at least in part, on one or more entries in a calendar application 107 (not shown for illustrative convenience) (e.g., a hairdresser appointment 2:00-3:00 p.m., a movie 8:00-9:00 p.m., and a birthday party at a fixed location).

In one embodiment, the system 100 determines one or more flexible parameters of at least one flexible appointment based, at least in part, on one or more fixed parameters of at least one fixed appointment (e.g., the hairdresser appointment). In particular, a user may want to know how he or she will get from one location to another (e.g., from his or her home to the hairdresser), when he or she will arrive at the next location, and/or when he or she should leave from one location to get to another. By way of example, the one or more flexible parameters, the one or more fixed parameters, or a combination thereof may include, at least in part, one or more location parameters, one or more time parameters, one or more transportation parameters, or a combination thereof. In this example use case, the system 100 can determine that the user has two flexible appointments as depicted by the respective dialogue boxers (e.g., “shopping” and “buying present”) based, at least in part, on one or more entries in a to-do list application 107 (not shown for illustrative convenience). As a result, in one embodiment, the system 100 can determine the one or more flexible parameters based, at least in part, on which one of the one or more flexible parameters will enable the user to arrive at the fixed appointments on time and also accomplish the flexible appointments in a reasonable manner (e.g., minimizing travel time, distance, and/or expense).

In one embodiment, the system 100 next determines at least one flow, at least one other flow, or a combination thereof of the at least one fixed appointment, the at least one flexible appointment, or a combination thereof based, at least in part, on at least one interaction with the mapping user interface 601 as depicted in FIG. 6B. In this example use case, the user knows that there is a shopping center near the location of the fixed hairdresser appointment and that he or she wants to accomplish the flexible shopping appointment after the fixed hairdresser appointment. In one embodiment, the system 100 can then determine the at least one flow or order based, at least in part, on the user moving (e.g., dragging and dropping) the interactive dialogue box 603 labeled “shopping,” for example, to the location of the shopping center on the mapping user interface 601 as depicted by the dashed lines. In this example use case, the user also knows that there is a gift shop near the fixed movie appointment and that he or she wants to go to the gift shop before the movie. Accordingly, the system 100 can further determine the at least one flow based, at least in part, on the user dragging and dropping, for example, the interactive dialogue box 605 labeled “buy present,” for example, to the location of the gift shop on the mapping user interface 601 as also depicted by the dashed lines.

In one embodiment, the system 100 determines at least one travel time, at least one recommended departure time, or a combination thereof based, at least in part, on the one or more flexible parameters. For example, in this example use case, the system 100 can determine that by walking, the user can reasonably get from the fixed hairdresser appointment to the flexible shopping appointment in approximately fifteen minutes. As a result, if the user leaves the hairdresser at the end of his or her appointment (e.g., at 3:00 p.m.), he or she should reasonably be able to arrive at the shopping complex by 3:15 p.m. Likewise, in this example use case, the system 100 can determine that if the user wants to take public transportation (e.g., a bus, a subway, etc.) between the flexible gift shop appointment and the fixed movie appointment, the user will need to leave the gift shop by 7:40 p.m. to arrive at the movies on time.

In one embodiment, the system 100 causes, at least in part, a presentation of the mapping user interface 601 depicting the one or more flexible parameters, the at least one flexible appointment, the one or more fixed parameters, the at least one fixed appointment, or a combination thereof as depicted in the mapping user interface 601 of FIG. 6C. In particular, in this example use case, the system 100 causes, at least in part, a presentation of the fixed appointments and the flexible appointments in terms of location, time, the relationship between the appointments, or a combination thereof using various dialogue boxes (e.g., the dialogue boxes 603 and 605). For example, the system 100 causes, at least in part, a presentation of the dialogue box 607 labeled “hairdresser 2:00-3:00” on the location of the hairdresser on the mapping user interface 601.

In one embodiment, once the system 100 determines that the user wants to take public transportation (e.g., a bus) to the fixed hairdresser appointment (e.g., by determining that the user has dragged and dropped the interactive bus glyph 609 between the dialogue box 611 labeled “home” and the hairdresser dialogue box 607), the system 100 can cause, at least in part, a presentation on the mapping user interface 601 of the dialogue box 613 that shows the user that he or she will have to leave his or her house by 1:30 p.m. to arrive that the fixed hairdresser appointment on time (e.g., at 2:00 p.m.). Thereafter, in one embodiment, once the system 100 determines that the user wants to walk from the hairdresser to the shopping center, (e.g., by determining that the user has dragged and dropped the interactive walking glyph 615 between the dialogue box 607 and 603), the system 100 causes, at least in part, a presentation of additional information in the dialogue box 603 (e.g., “shopping arrive at 3:15”) so that the user knows based, at least in part, on his or her selection of the one or more flexible parameters (e.g., walking) that it will take him or her approximately fifteen minutes to walk from the fixed hairdresser appointment to the flexible shopping appointment.

Continuing with this example use case, the system 100 determines that the user wants to drive home from the shopping center (e.g., a user may be carrying a number of bags) based, at least in part, on the user dragging and dropping, for example, the interactive car glyph 617 on the mapping user interface 601 between the dialogue boxes 603 and 611 of the flexible shopping appointment and the fixed home location, respectively. Thereafter, in one embodiment, the system 100 causes, at least in part, a presentation on the mapping user interface 601 of the dialogue box 619 showing the user that by driving, it will take the user approximately fifteen minutes to get home. In one embodiment, the system 100 then determines that the user has scheduled approximately 30 minutes to look for a gift at the gift shop (e.g., based on an entry in the to-list application 107) and that the user wants to travel by bus based, at least in part, on the user dragging and dropping, for example, the interactive bus glyph 609 on the mapping user interface 601 between the fixed location home 611 and the flexible gift shop appointment. Consequently, in this example use case, the system 100 causes, at least in part, a presentation on the mapping user interface 601 of the dialogue box 621 showing the user that he or she should leave his or her house by 6:30 p.m. to be at the gift shop by 7:10 p.m. by bus.

Further, in this example use case, the system 100 determines that after the movie the user will go by bus to the fixed birthday party appointment based, at least in part, on the user dragging and dropping, for example, the interactive bus glyph 609 on the mapping user interface 601 between the dialogue boxes 623 and 625 of the fixed movie appointment and the fixed birthday party appointment, respectively. Subsequently, the system 100 causes, at least in part, a presentation of the dialogue box 627 labeled “arrive around 10:15,” which informs the user that he or she should arrive at the fixed birthday party appointment at that time by taking a bus. Thereafter, the system 100 can determine that the user wants to travel home by car, for example, based, at least in part, on the user dragging and dropping, for example, the interactive car glyph 617 between the dialogue boxes 625 and 611 of the fixed birthday party appointment and the fixed location home, respectively. Consequently, in one embodiment, the system 100 causes, at least in part, a presentation on the mapping user interface 601 of the dialogue box 629 labeled “takes 35 minutes,” which shows the user how long the trip home will take by car.

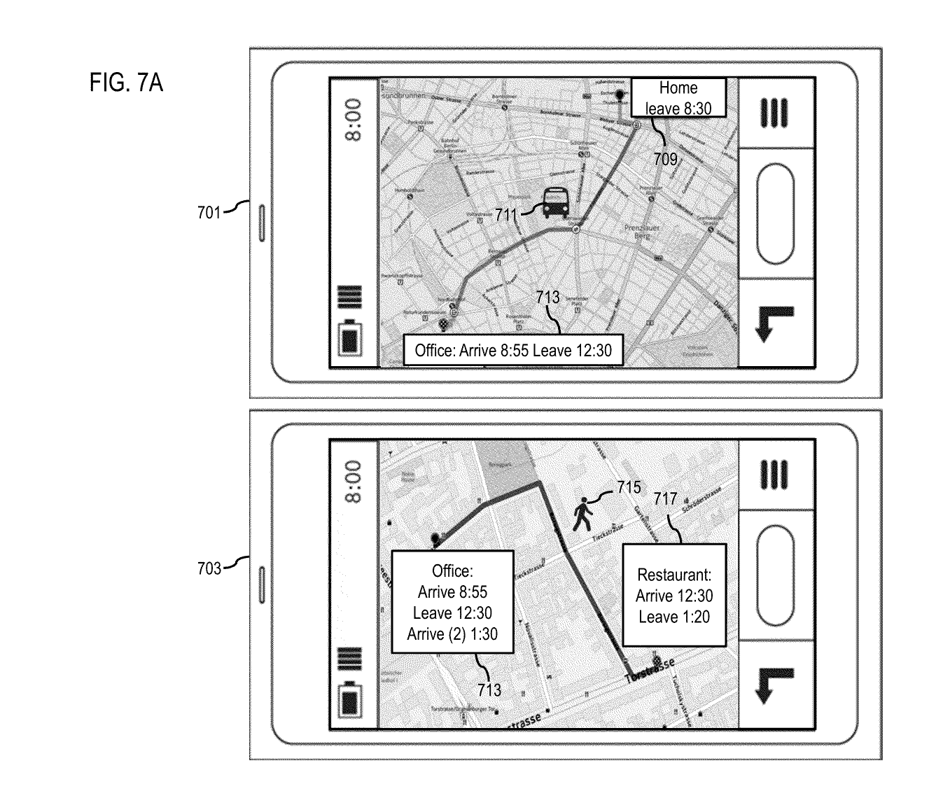

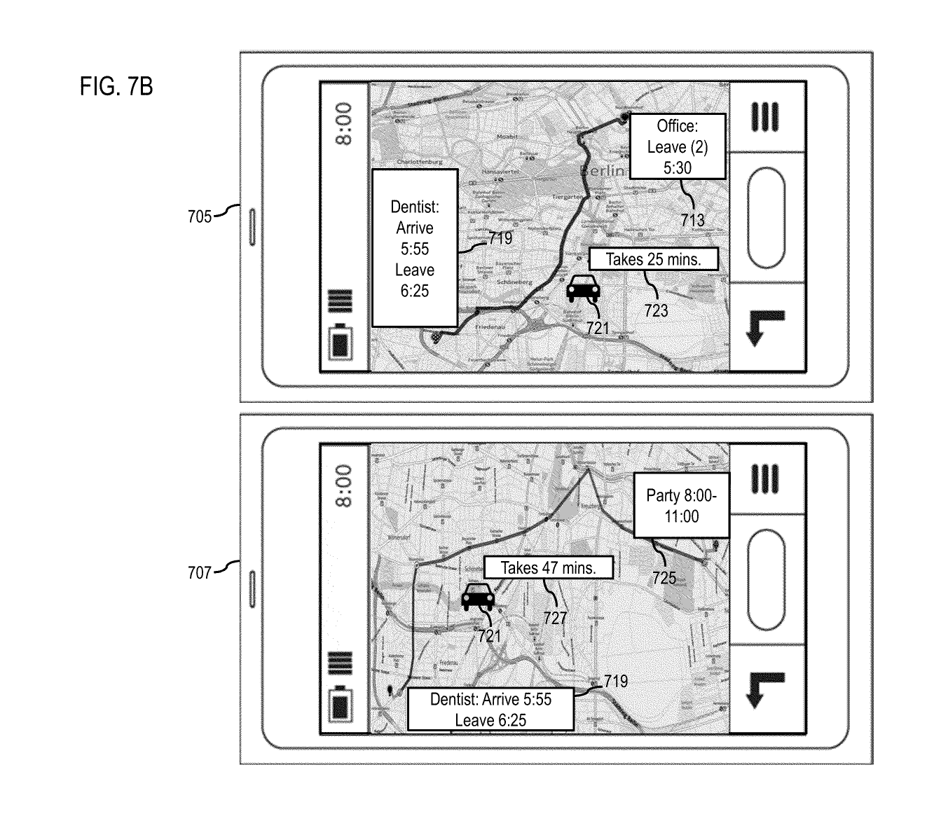

FIGS. 7A and 7B are diagrams of user interfaces utilized in the processes of FIGS. 3-5, according to various embodiments. As shown, the example user interfaces of FIGS. 7A and 7B include one or more user interface elements and/or functionalities created and/or modified based, at least in part, on information, data, and/or signals resulting from the processes (e.g., processes 300, 400, and 500) described with respect to FIGS. 3-5. More specifically, FIGS. 7A and 7B illustrate four user interfaces (e.g., interfaces 701, 703, 705, and 707), depicting a review of an already planned day (e.g. a weekday). More specifically, in one embodiment, it is contemplated that the system 100 can cause, at least in part, a presentation showing a user his or her entire day on the mapping user interface and that each interface (e.g., interfaces 701, 703, 705, and 707 represents a panning of the mapping user interface (e.g., the mapping user interface 601 of FIGS. 6A-6C). By way of example, the system 100 can determine that it is a Thursday from the satellites 117, for example, that Thursday is a workday (e.g., based on the location of the interfaces 701, 703, 705, and 707), and that the user has two fixed appointments (e.g., a dentist appointment at 5:55 p.m. and a party at 8:00 p.m.) scheduled for the day based, at least in part, on one or more entries in a calendar application 107, for example.

In this example use case, the system 100 has already determined the one or more flexible parameters of the at least one flexible appointment based, at least in part, on the one or more fixed parameters of the at least one fixed appointment. Therefore, in this example use case, the system 100 simply causes, at least in part, a presentation of a mapping user interface depicting the one or more flexible parameters, the at least one flexible appointment, the one or more fixed parameters, the at least one fixed appointment, or a combination thereof as shown in interfaces 701, 703, 705, and 707. For example, in this example use case, the system 100 causes, at least in part, a presentation in the interface 701 of a dialogue box 709 that shows the user that at the start of his or her day, the user needs to leave his or her home at 8:30 a.m. to get to get to work on time for a 9:00 a.m. meeting by taking public transportation (e.g., a bus) as depicted by the bus glyph 711. Moreover, the system 100 causes, at least in part, a presentation of a dialogue box 713 that shows the user that he or she will arrive at his or her office at 8:55 a.m., just in time for the 9:00 a.m. meeting, and that he or she needs to leave by 12:20 p.m. to meet a friend for lunch by walking as shown by the walking glyph 715 of interface 703.

In one embodiment, at the same time, the system 100 causes, at least in part, a presentation in interface 703 of the dialogue box 717 associated with a fixed restaurant appointment that is scheduled for 12:30-1:30 p.m. More specifically, once the system 100 determines that the user has arrived at the restaurant, in one embodiment, the system 100 can cause, at least in part, an update of the dialogue box 713 of interface 701 so that the user will now know that by walking he or she will get back to his or her office by 1:30 p.m. as depicted by the dialogue box 713 of the interface 703.

In one or more embodiments, at the same time, the system 100 also causes, at least in part, the presentation of dialogue boxes 713 and 719 of the fixed office and dentist appointments, respectively, as depicted in the interface 705 of FIG. 7B. More specifically, in one embodiment, the system 100 causes, at least in part, another update of the dialogue box 713 to now inform the user that he or she needs to leave his or her office at 5:30 p.m. to go the fixed dentist appointment 719 by car as depicted by the car glyph 721 and the dialogue box 723 labeled “takes 25 minutes.” As previously discussed, in one embodiment, the system 100 can determine free-time information based, at least in part, on the one or more fixed parameters, the at least one fixed appointment, or a combination thereof. In this example use case, the system 100 determines that the user's dentist appointment ends at 6:25 p.m. as shown in the dialogue box 719 and that the user's next appointment is not until the birthday party at 8:00 p.m. as shown in the dialogue box 725, however, the user will need approximately 47 minutes to get to the party by car as shown by the car glyph 721 and the dialogue box 727. Therefore, the system 100 determines that the user has approximately 48 minutes of free time to try and accomplish one or more flexible appointments. As previously discussed, in one embodiment, where a user is unfamiliar with the area around the at least one fixed appointment (e.g., the dentist appointment), the system 100 can determine one or more relevant POIs proximate to the fixed dentist appointment in the mapping user interface of interface 707, for example, based, at least in part, on the at least one flexible appointment, the at least one fixed appointment, or a combination thereof. By way of example, if the user wants to see if there are any restaurants around the fixed dentist appointment and/or between the fixed dentist appointment and the fixed party appointment, the system 100 can cause, at least in part, a presentation of one or more relevant POIs proximate to the fixed dentist appointment, for example, which the user can then choose among.

The processes described herein for visualizing a flow of fixed and flexible daily calendar appointments on a mapping user interface including time, location, and/or transportation information associated with the appointments may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

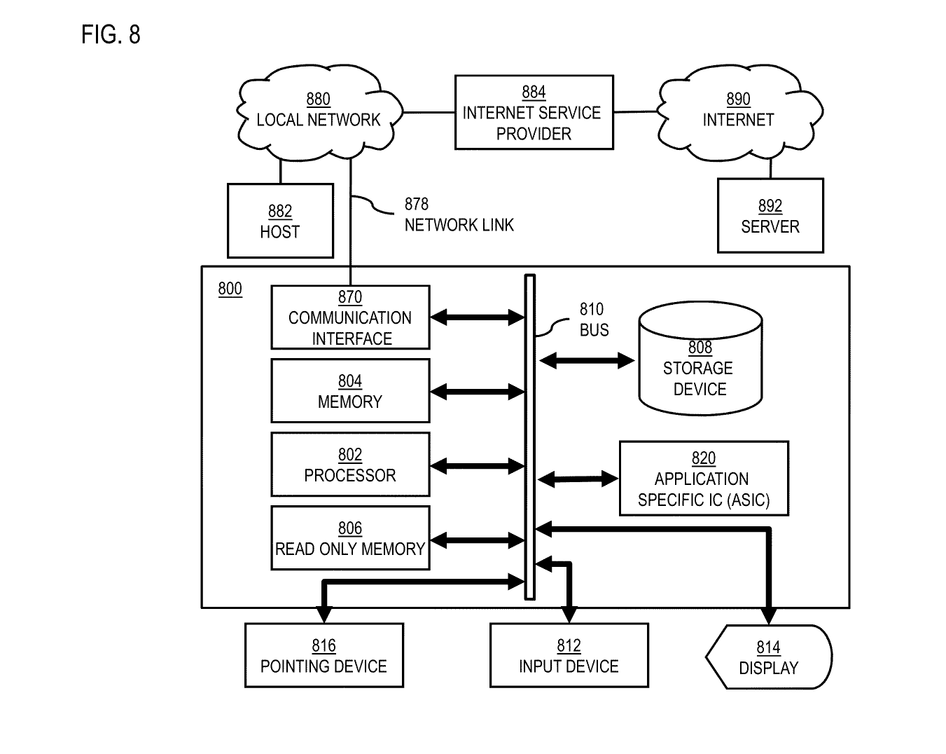

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to visualize a flow of fixed and flexible daily calendar appointments on a mapping user interface including time, location, and/or transportation information associated with the appointments as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of visualizing a flow of fixed and flexible daily calendar appointments on a mapping user interface including time, location, and/or transportation information associated with the appointments.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to visualize a flow of fixed and flexible daily calendar appointments on a mapping user interface including time, location, and/or transportation information associated with the appointments. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for visualizing a flow of fixed and flexible daily calendar appointments on a mapping user interface including time, location, and/or transportation information associated with the appointments. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for visualizing a flow of fixed and flexible daily calendar appointments on a mapping user interface including time, location, and/or transportation information associated with the appointments, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for visualizing a flow of fixed and flexible daily calendar appointments on a mapping user interface including time, location, and/or transportation information associated with the appointments to the UEs 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to visualize a flow of fixed and flexible daily calendar appointments on a mapping user interface including time, location, and/or transportation information associated with the appointments as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of visualizing a flow of fixed and flexible daily calendar appointments on a mapping user interface including time, location, and/or transportation information associated with the appointments.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to visualize a flow of fixed and flexible daily calendar appointments on a mapping user interface including time, location, and/or transportation information associated with the appointments. The memory 905 also stores the data associated with or generated by the execution of the inventive steps.

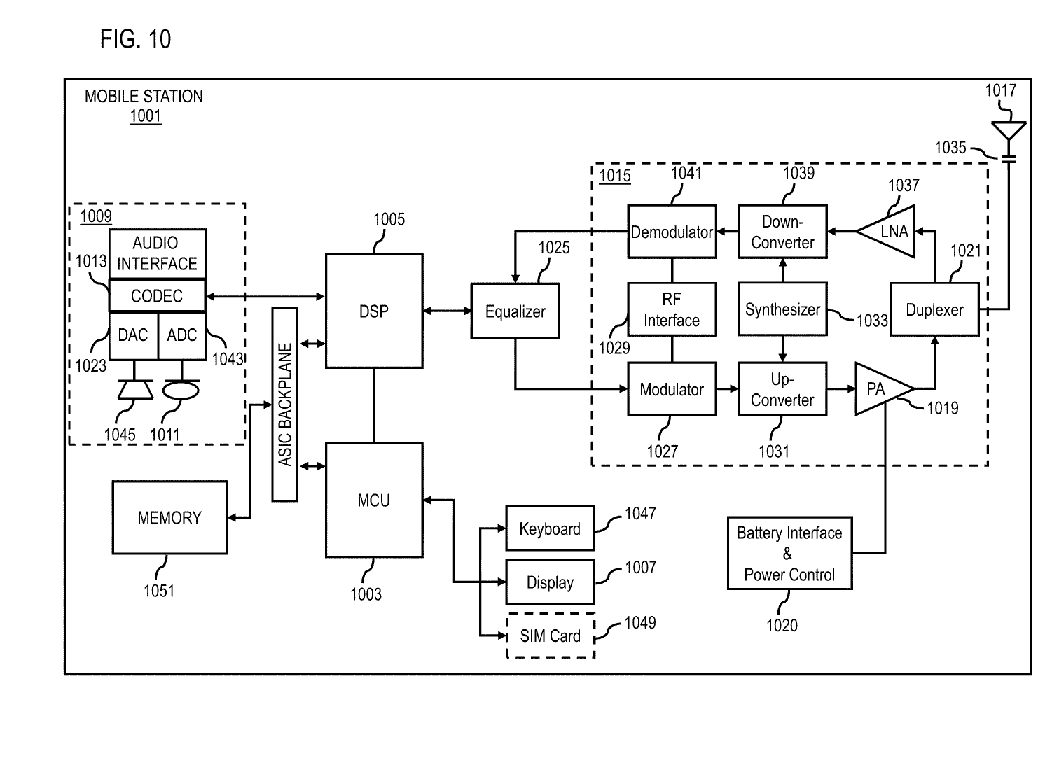

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of visualizing a flow of fixed and flexible daily calendar appointments on a mapping user interface including time, location, and/or transportation information associated with the appointments. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of visualizing a flow of fixed and flexible daily calendar appointments on a mapping user interface including time, location, and/or transportation information associated with the appointments. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to visualize a flow of fixed and flexible daily calendar appointments on a mapping user interface including time, location, and/or transportation information associated with the appointments. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more flexible parameters of at least one flexible appointment based, at least in part, on one or more fixed parameters of at least one fixed appointment; and
a presentation of at least one mapping user interface depicting the one or more flexible parameters, the at least one flexible appointment, the one or more fixed parameters, the at least one fixed appointment, or a combination thereof,
wherein the one or more flexible parameters, the one or more fixed parameters, or a combination thereof include, at least in part, one or more location parameters, one or more time parameters, one or more transportation parameters, or a combination thereof.

2. A method of claim 1, wherein the (1) data and/or (2) information and/or (3) at least one signal are further based, at least in part, on the following:
at least one determination of free-time information based, at least in part, on the one or more fixed parameters, the at least one fixed appointment, or a combination thereof,
wherein the one or more flexible parameters, the at least one flexible appointment, or a combination thereof is further based, at least in part, on the free-time information.

3. A method of claim 1, wherein the (1) data and/or (2) information and/or (3) at least one signal are further based, at least in part, on the following:
at least one determination of at least one flow, at least one other flow, or a combination thereof of the at least one fixed appointment, the at least one flexible appointment, or a combination thereof based, at least in part, on at least one interaction with the at least one mapping,
wherein the presentation is further based, at least in part, on the at least one flow, the at least one other flow, or a combination thereof.

4. A method of claim 1, wherein the (1) data and/or (2) information and/or (3) at least one signal are further based, at least in part, on the following:
at least one determination of at least one travel time, at least one recommended departure time, or a combination thereof based, at least in part, on the one or more flexible parameters,
wherein the presentation is further based, at least in part, on the at least one travel time, the at least one recommended departure time, or a combination thereof.

5. A method of claim 1, wherein the (1) data and/or (2) information and/or (3) at least one signal are further based, at least in part, on the following:
at least one determination of one or more points of interest proximate to the at least one fixed appointment in the at least one mapping user interface based, at least in part, on the at least one flexible appointment, the at least one fixed appointment, or a combination thereof,
wherein the presentation is further based, at least in part, on the one or more points of interest.

6. A method of claim 1, wherein the (1) data and/or (2) information and/or (3) at least one signal are further based, at least in part, on the following:
at least one determination of context information associated with at least one device depicting the at least one mapping user interface,
wherein the at least one fixed appointment is based, at least in part, on the context information.

7. A method of claim 1, wherein the (1) data and/or (2) information and/or (3) at least one signal are further based, at least in part, on the following:
at least one determination of other context information associated with the at least one device, at least one user of the at least one device, or a combination thereof,
wherein the one or more flexible parameters, the at least one flexible appointment, or a combination thereof is further based, at least in part, on the other context information.

8. A method of claim 1, wherein the (1) data and/or (2) information and/or (3) at least one signal are further based, at least in part, on the following:
at least one determination of at least one other flexible appointment, at least one other fixed appointment, or a combination thereof associated with one or more other users,
wherein the presentation is further based, at least in part, on the at least one other flexible appointment, the at least one other fixed appointment, or a combination thereof.

9. A method of claim 1, wherein the (1) data and/or (2) information and/or (3) at least one signal are further based, at least in part, on the following:
at least one determination of at least one change of the one or more time parameters, the one or more location parameters, the one or more transportation parameters, or a combination thereof in substantially real-time, periodically, according to a schedule, on demand, or a combination thereof,
wherein the one or more flexible parameters, the at least one flexible appointment, or a combination thereof is further based, at least in part, on the at least one change.

10. A method of claim 1, wherein the (1) data and/or (2) information and/or (3) at least one signal are further based, at least in part, on the following:
at least one determination of at least one interaction with at least one other user interface of the at least one device depicting one or more time frames,
wherein the presentation is further based, at least in part, on the at least one interaction.

11. An apparatus comprising:
at least one processor; and
at least one memory including computer program code for one or more programs,
the at least one memory and the computer program code configured to, with the at least one processor, cause the apparatus to perform at least the following,
determine one or more flexible parameters of at least one flexible appointment based, at least in part, on one or more fixed parameters of at least one fixed appointment; and
cause, at least in part, a presentation of at least one mapping user interface depicting the one or more flexible parameters, the at least one flexible appointment, the one or more fixed parameters, the at least one fixed appointment, or a combination thereof,
wherein the one or more flexible parameters, the one or more fixed parameters, or a combination thereof include, at least in part, one or more location parameters, one or more time parameters, one or more transportation parameters, or a combination thereof.

12. An apparatus of claim 11, wherein the apparatus is further caused to:
determine free-time information based, at least in part, on the one or more fixed parameters, the at least one fixed appointment, or a combination thereof,
wherein the one or more flexible parameters, the at least one flexible appointment, or a combination thereof is further based, at least in part, on the free-time information.

13. An apparatus of claim 11, wherein the apparatus is further caused to:
determine at least one flow, at least one other flow, or a combination thereof of the at least one fixed appointment, the at least one flexible appointment, or a combination thereof based, at least in part, on at least one interaction with the at least one mapping,
wherein the presentation is further based, at least in part, on the at least one flow, the at least one other flow, or a combination thereof.

14. An apparatus of claim 11, wherein the apparatus is further caused to:
determine at least one travel time, at least one recommended departure time, or a combination thereof based, at least in part, on the one or more flexible parameters,
wherein the presentation is further based, at least in part, on the at least one travel time, the at least one recommended departure time, or a combination thereof.

15. An apparatus of claim 11, wherein the apparatus is further caused to:
determine one or more points of interest proximate to the at least one fixed appointment in the at least one mapping user interface based, at least in part, on the at least one flexible appointment, the at least one fixed appointment, or a combination thereof,
wherein the presentation is further based, at least in part, on the one or more points of interest.

16. An apparatus of claim 11, wherein the apparatus is further caused to:
determine context information associated with at least one device depicting the at least one mapping user interface,
wherein the at least one fixed appointment is based, at least in part, on the context information.

17. An apparatus of claim 11, wherein the apparatus is further caused to:
determine other context information associated with the at least one device, at least one user of the at least one device, or a combination thereof,
wherein the one or more flexible parameters, the at least one flexible appointment, or a combination thereof is further based, at least in part, on the other context information.

18. An apparatus of claim 11, wherein the apparatus is further caused to:
determine at least one other flexible appointment, at least one other fixed appointment, or a combination thereof associated with one or more other users,
wherein the presentation is further based, at least in part, on the at least one other flexible appointment, the at least one other fixed appointment, or a combination thereof.

19. An apparatus of claim 11, wherein the apparatus is further caused to:
determine at least one change of the one or more time parameters, the one or more location parameters, the one or more transportation parameters, or a combination thereof in substantially real-time, periodically, according to a schedule, on demand, or a combination thereof,
wherein the one or more flexible parameters, the at least one flexible appointment, or a combination thereof is further based, at least in part, on the at least one change.

20. An apparatus of claim 11, wherein the apparatus is further caused to:
determine at least one interaction with at least one other user interface of the at least one device depicting one or more time frames,
wherein the presentation is further based, at least in part, on the at least one interaction.

21-48. (canceled)
